(19) United States
(12) Patent Application Publication
(10) Pub. No.: US 2002/0145232 A1
(43) Pub. Date: Oct. 10, 2002

(54) Machine for casting radiation cured material and process for making same

(76) Inventors: Gregory C. Zettel, Douglas, GA (US); Donald L. Sudduth, Torrance, CA (US)

Correspondence Address: Gregory C. Zettel, 5512 Riviera Way, Torrance, CA, 90505, US

(21) Appl. No.: 09/827,082

(22) Filed: Apr. 5, 2001

(51) Int. Cl. B29C 35/08; B29C 41/04; B29C 41/06; B29C 45/00

(52) U.S. Cl. 264/310; 264/311; 264/478; 264/496; 425/174.4; 425/429

(57) ABSTRACT

A machine for casting radiation cured material with a mold set made of a clear, radiation cured material or other clear material, one or more radiation emitting devices preferably in the ultraviolet and visible range, a rotating mechanism to move the mold set from a horizontal or vertical load/unload position to vertical fill and cure position at the radiation devices, and one or more injection mechanisms attached to the mold set to fill the mold set and then seal at the part wall preventing cure of material in the line and resulting in a minimal gate mark. Alternatively the molds can be filled and then rotated before and during cure to create a hollow part.

### BACKGROUND OF THE INVENTION

This invention relates generally to the field of plastic molding, and more particularly to a machine for casting radiation cured material and process for making same.

The injection molding industry has evolved to a uniform industry that is generally geared to high volume production of very inexpensive products. The price of this is in high cost and extensive lead-time of tooling to produce the parts. The equipment used is extremely expensive and has many controls to hold all the variables at precise levels, Equipment needs to be operated continuously to reduce the extensive scrap generated while the equipment is brought up to uniform operating temperature, Many quality problems of the product are a result of the shrinkage of the material from a hot liquid form to the resulting cool solid. These problems are overcome by setting a rigid system and requiring low variability. If the volume of parts does not justify the expense of tooling and this system of control, the cost of the part can be prohibitively expensive. Also, new changes to improve the product or meet customer desires are many times not economical to implement due to these high costs.

Radiation cured plastics are currently in use in many applications. This technology does not require melting of the raw material and cooling/curing but instead solidifies the material with photoinitiators. The result is a variety of plastic materials that do not require heat and pressure to mold and can have little or no shrink.

Some current processes use a mold fixture to produce light cured plastic molds but do not describe controls to insure minimal mismatch or methods to produce more complex parting lines. Current machines and processes for radiation cured casting or molding do not address producing product in injection molded, insert injection molded, and rotary molded form.

Other advances in plastic injection molding can also be applied such as the use of a hot runner type pin gate to provide for a more continuous process as well as to reduce the gate witness that improves the appearance of the parts as well as reducing subsequent operations. Selective curing can also be applied to control which areas solidify first and thereby reduce effects of dimensional shrinkage and dimensional distortion.

### SUMMARY OF THE INVENTION

The primary object of the invention is to provide a machine and process that produces injection molded plastic parts without expensive tooling.

Another object of the invention is to begin initial production of injection molded plastic parts without excessive lead times to produce tooling.

Another object of the invention is to provide a machine and process that produces plastic molded parts with a faster cycle time.

A further object of the invention is to provide a machine and process that produces injection molded plastic parts that is inexpensive, simple to operate, and does not have to be run continuously to significantly reduce equipment set up/warm up scrap.

Yet another object of the invention is to provide a machine and process that produces injection molded plastic parts that is much smaller than present equipment.

Still yet another object of the invention is to produce injection molded plastic parts with much less power consumption.

A further object of the invention is to produce injection molded plastic parts without the use of volatile organic compounds or styrene.

Another object of the invention is to produce injection molded plastic parts without high temperature and pressure that can damage items insert molded, therefore reducing the need for subsequent assembly operations.

Another object of the invention is to provide a machine and process that produces injection molded plastic parts that includes selective curing to reduce or eliminate geometric distortion and/or shrinkage.

A further object of the invention is to provide a machine and process that can be adapted for injection molding, insert injection molding, or rotary molding.

Yet another object of the invention is to provide a machine and process that produces injection molded parts with flush gate marks that do not require subsequent gate removal operations.

Other objects and advantages of the present invention will become apparent from the following descriptions, taken in connection with the accompanying drawings, wherein, by way of illustration and example, an embodiment of the present invention is disclosed.

A. A machine for casting radiation cured material comprising: a mold set made of a clear, radiation cured material or other clear material, one or more radiation emitting devices preferably in the ultra violet and visible range, a rotating mechanism to move the mold set from a horizontal or vertical load/unloaded position to vertical fill and cure position at the radiation devices, and one or more injection mechanisms attached to the mold set to fill the mold set and then seal at the part wall preventing cure of material in the line.

B. A process for casting radiation cured material comprising the steps of: a mold set made of a clear, radiation cured material or other clear material, one or more radiation emitting devices preferably in the ultra violet and visible range, a rotating mechanism to move the mold set from a horizontal or vertical load/unload position to vertical fill and cure position at the radiation device, and one or more injection mechanisms attached to the mold set to fill the mold and then seal at the part wall preventing cure of material in the line.

C. A machine for casting radiation cured material comprising the steps of: a mold set made of a clear, radiation cured material or other clear material, one or more radiation emitting devices preferably in the ultra violet and visible range, a rotating mechanism to move the mold set from a horizontal or vertical load/unload position to vertical fill and cure position at the radiation device, one injection mechanism to partially fill the mold cavity after which said injection mechanism is removed and a tube is inserted to vent the mold cavity, and a method for rotating the mold simultaneously in two axis 90 degrees apart while at the cure station to evenly coat the inside of the mold with radiation curable material prior to and during curing.

D. A process for casting radiation cured material comprising the steps of: a mold set made of a clear, radiation cured material or other clear material, one or more radiation emitting devices preferably in the ultra violet and visible range, a rotating mechanism to move the mold set from a horizontal or vertical load/unload position to vertical fill and cure position at the radiation device, one injection mechanism to partially fill the mold cavity after which a tube is inserted to vent the said cavity, and a method for rotating the mold simultaneously in two axis 90 degrees apart while at the cure station to evenly coat the inside of the mold with radiation curable material prior to and during curing.

E. An open metal box to create mold halves for inventions A, B, C, and D comprising of: dowel pins which accurately locate the pattern halves in the box, conical pins and holes to properly orient the matching mold halves, and has a means to create openings for the injection mechanisms such as properly shaped pins secured to the box.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of the first embodiment of the invention.

FIG. 2 is a cross sectional view of the mold set and injection device during fill sequence.

FIG. 3 is an exploded perspective view of mold making box prior to introduction of mold material.

FIG. 4 is a plan view of the mold set showing the movement of the shutter during radiation exposure.

FIG. 5 is a perspective view of the rotational embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

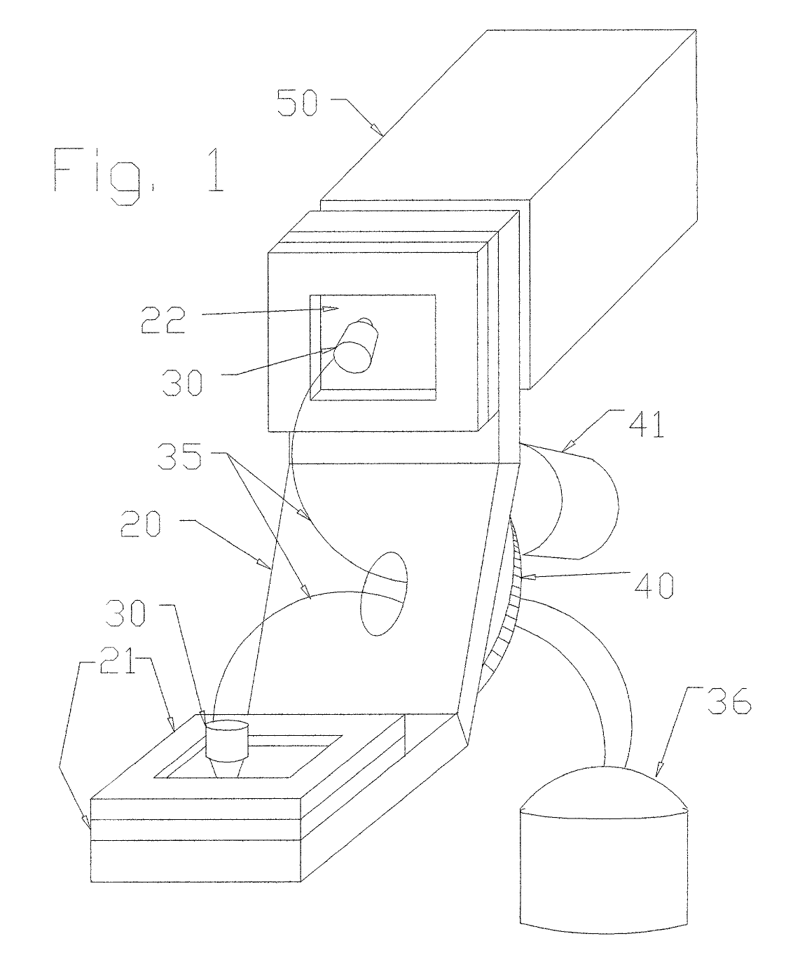

In FIG. 1 a rotating mechanism is shown comprising a rotating member 20 on which is attached on either end mold holding members 21. On each end, two mold holders restrain a mold set 20, which contains a cavity, which accurately describes the shape of the part to be created from the casting process. The molds have been created with an opening, which matches the geometry of the injection device 30, which is secured to the top of the mold holding member, and therefore fixed with respect to the top of the mold set. The injection devices 30 are fed material through tubes 35, which are opaque to radiation, used to cure the material, such as ultraviolet light and visible, and are attached to a pressurized container 36. The container may be pressurized by a cylinder of compressed gas keeping the material clean or alternatively the material could be pumped from the container to the injection devices 30. A gear 40 or other means to move the rotating member is driven with a motor 41.

In the operation of machine shown in FIG. 1 the mold holders 21 containing the mold set 22 are manually or automatically closed and the motor is activated to rotate the mold set 22 up to a position where the window in one or both sides of the mold holders are exposed to a radiation emitting device 50. FIG. 1 shows one such radiation emitting device but another could be located on the same side as the injection device 30. Not shown is a cover around the curing station, which is required to contain radiation within the station. After the mold is closed and during the rotation the injection device 30 is activated either electrically or pneumatically which fills the mold cavity with radiation curable material. As material enters the cavity the air in the cavity is forced out at the parting line of the mold and as such another opening in the mold for venting is not required. This venting is facilitated by the vertical orientation of the mold set at the curing station. This eliminates the need to either remove the vent from the final part or reduces the need for another injection device for venting.

As the mold set arrives at the radiation emitting device the material can be exposed by its position at the radiation station or a shutter can be used to direct sequential curing resulting in the same benefits as described in U.S. Pat. No. 5,114,632 to Soane, which are more accurate dimensional characteristics and reduced effects of shrinkage such as bubble formation and sink in the final part. During this exposure of the first mold set the other mold set on the other end of the rotating member 20 has arrived at the load/unload station where the part is removed and the mold closed for the next cycle.

The load/unload station is horizontal to facilitate loading of an insert into the mold for an insert injection molded part. This could comprise of any assembly, which is required to be partial or fully submerged in the final part as well as another plastic part as is used as part of a sequentially molded component. In sequential molding a part generally is molded from a material, which is different in color, hardness, or other characteristic and is then inserted in a mold and another material is joined with the first material. Insert molding can also be used to create composites by inserting material such as glass or carbon fiber to improve physical properties of the final part. If an insert is not required the load/unload station can be make vertical to facilitate ejection of the part.

The machine continues in this fashion rotating in alternating directions and as such the tubes 35 can be run directly to the material container 36 without passing through some type of rotary coupling which is more expensive, can leak, and will eventually wear out. Stop switches are used to stop rotation and reverse direction of rotation for the next cycle.

The use of the rotating table with the injection devices and pressurized container represents a considerable improvement over U.S. Pat. No. 5,965,170 to Matsuoka, et al. as in that described equipment the cycle time to evacuate to chamber to pour the material is unacceptably long, the labor to move the mold from station to station is significant, and the curing is not as controlled to prevent shrinkage. As a result a high quality part can be produced with the rotating device in a few seconds as opposed to several minutes with the vacuum chamber and rollers.

Not shown is a method to close and hold the mold sets closed during injection of the molding material and curing which could be hydraulic, pneumatic, or be a simple hand operated over center clamp which would swirn the top of the mold and mold holder into position over the bottom and then lock the two halves together. This over center clamp could also be hydraulically or pneumatically activated.

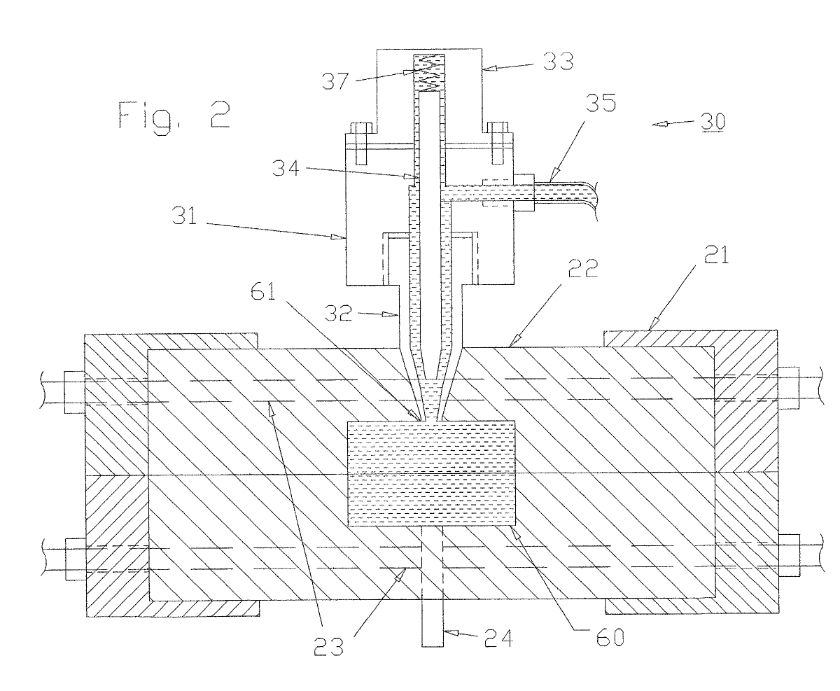

FIG. 2 shows a closer view of the injection device 30 and mold set 22 during injection. Material is fed through tube 35 into the valve body 31 and through mold tube 32. When a solenoid 33, or alternatively a pneumatic actuator, is energized pin 34 is lifted opening gate 61 into the part cavity 60. When the activation device is de-energized the spring 37 closes the gate blocking the radiation from entering the inside of the injection device. In this way all material is used in the part. No material is wasted in runners, which also would then need to be removed and disposed. Operation of the injection device can be controlled by a timer to control amount of material delivered or sensors could be used to determine amount of fill or radiation shutter location. Cooling lines 23 which pass through the mold holders 21 and connect to a chilling unit are shown which can be used if required for some parts to remove the heat generally produced from the exothermic reaction in the part material as well as any heating which occurs from any infrared radiation component of the radiation source. Ejection pins 24 can be used to release the part from the mold after solidification. The pins can be steel or a clear material and are linked to the top mold holder 21 so that when the mold is opened the pin moves into the mold cavity pushing the finished part from the mold. This is particularly useful when the load/unload station is vertical and operated automatically as the part ejection is insured and extremely fast cycle times are possible.

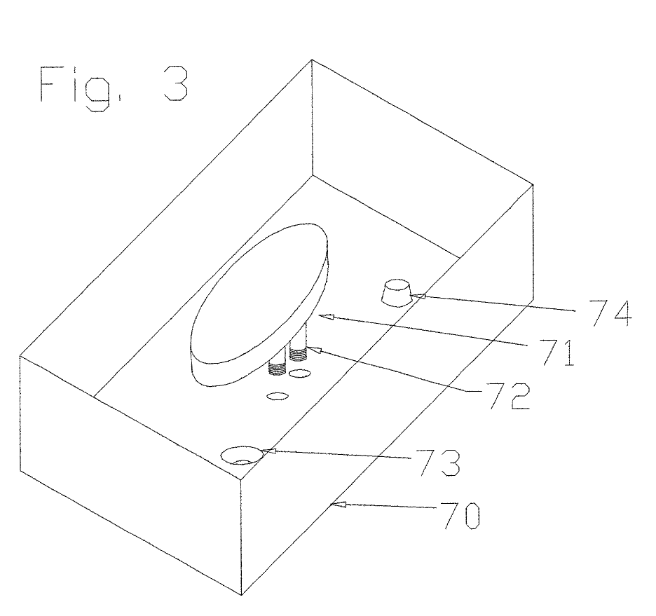

FIG. 3 shows the method for making the molds for the machine in FIG. 1. A box is used to contain the mold material prior to solidification. Half of a sample of the part to be produced 71 is mounted to the bottom of the box with dowel pins to insure positive location with respect to the sides of the box. The sample can be an existing part or created by a rapid prototype process or cut from a metallic material using traditional milling or EDM methods. Negative and positive conical locators 73 and 74 are used to locate the two halves to each other during the part molding process. Pins for the cooling channels can be added to the box if desired. A clear mold material can then be added to the box to cover the components of the mold. After exposure to radiation for solidification the sides of the box are removed and the mold installed in the machine in FIG. 1. The process is then repeated for the other half of the mold set. Mold material can be of any material that transmits the radiation emitted for curing purposes including ultraviolet cured material or molten quartz.

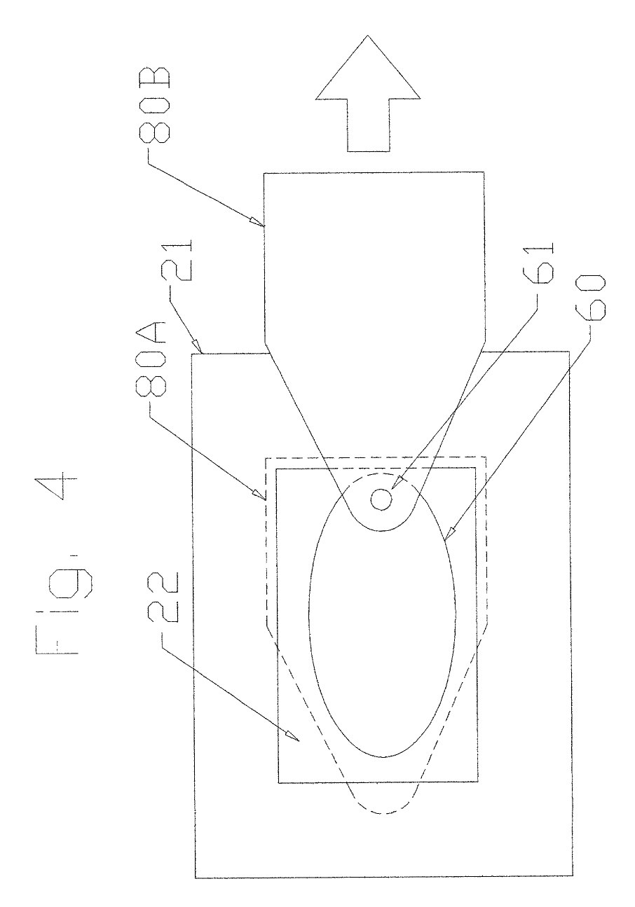

In FIG. 4 a plan view of the mold set 22 and mold holders 21 shows the action of a shaped shutter 80A-80B as it is moved from the initial position 80A to an intermediate position 80B where most of the part is exposed except gate area 61. This allows the part to cure sequentially while the gate continues to feed material into the mold cavity 60. The injection device is then closed and the shutter is further moved to the right to cure the remainder of the part. The shutter could also be shaped to cure a thicker section say at the bottom of the figure first to allow for continued feeding through thinner sections to reduce dimensional distortion. This is similar to metal casting and traditional plastic injection molding where heat dissipation is used to control shrinkage amount and location within those products.

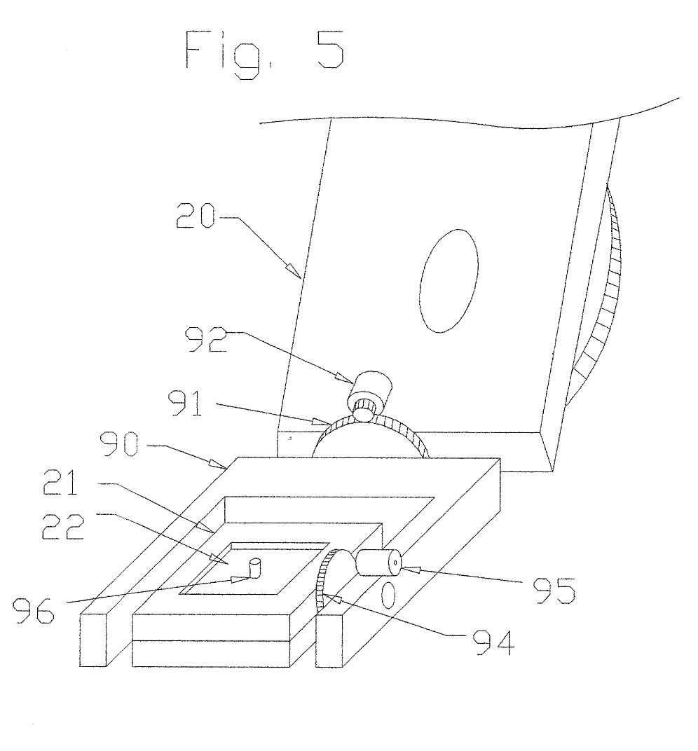

In FIG. 5 another embodiment of the invention is one, which incorporates rotational molding of the part. This reduces the amount of material required, makes the part lighter, and results in a hollow part. The rotating member is attached to a rotating plate 90, which is turned by a gear 91 driven by a motor 92. Again different types of drive mechanisms and motors may be used. The mold holders 21 and the mold set 22 are then attached to the rotating plate 90 by a pin 93 on either side of the mold holder 21. A gear 94 driven by a motor 95 rotates the mold holders In this application a tube 96 is required to vent the center of the mold as it is moved to the cure station and exposed. Speeds of the motors are adjusted to create a uniform coating of the inside of the mold. Power can be provided to the motor 95 by a brush attached to the rotating member 20 touching a conducting ring on the side of gear 91 and grounding through the rotating member 20 and rotating plate 90.

The energy required to run this mechanism including the radiation source is a small fraction of the amount required to operate a traditional molding press or rotational molding device as the material traditionally used must be heated to the melting point, forced into the mold under great pressure, then further energy is expended in cooling the material in the mold to speed the cycle of the equipment. Another advantage is that many objects that cannot be inserted in a traditional mold due to these high temperatures and pressures can be insert molded with the described machine and process. Yet another important advantage is that the material used in the mold sets or parts do not contain volatile organic compounds or styrene and as such create a safer working environment.

From FIG. 3 it can also be see that the cost to produce a mold set is much less than traditional steel or even aluminum tooling. The tooling does not produce as many parts but hundreds of tools can be made at less cost. The box and sample used can be steel and be used to create the hundreds of mold sets required. The equipment described is smaller, simpler, more inexpensive, and easier to operate than previous technology. The most important advantage of the machine and process is the ability to start high volume production quantities in a few days as opposed to the many weeks required to build the complex tooling required for the traditional processes. This advantage is also important in the implementation of quality improvements or product enhancements.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for casting radiation cured material comprising:
a mold set made of a clear, radiation cured material or other clear material;
one or more radiation emitting devices preferably in the ultraviolet and visible range;
a rotating mechanism to move the mold set from a horizontal or vertical load/unload position to vertical fill and cure position at the radiation devices; and
one or more injection mechanisms attached to the mold set to fill the mold set and then seal at the part wall preventing cure of material in the line.

2. The invention of claim 1 with a pressurized container or pump to deliver radiation curable material to the injection mechanisms.

3. The invention of claim 1 with a method to operate the injection mechanisms to insure filling of the mold and closing of the said injection mechanisms before radiation strikes the gate it feeds which could include timers or sensors to detect fill or radiation shutter location.

4. The invention of claim 1 with a method to automatically stop the rotating mechanism and reverse rotation at that point.

5. The invention in claim 1 with either a method for the operator to activate the rotating mechanism or alternatively to permit the said rotating mechanism to cycle automatically.

6. The invention of claim 1 with a shaped shutter for the radiation source that can be designed to selectively irradiate portions of the part in sequence as it is withdrawn from in front of said radiation source.

7. The invention of claim 1 with a chilling unit and lines leading to holes in one or both mold halves to cool the mold.

8. The invention of claim 1 with an automatic mold opening and closing device to improve cycle time.

9. The invention of claim 1 with a method to eject the part with a pin or other means to positively remove the part from the mold set.

10. The invention of claim 1 with the rotating mechanism having more than two mold sets to include a rotary table with various stations for additional injections, insertions, cooling, or other functions.

11. A process for casting radiation cured material comprising the steps of:
a mold set made of a clear, radiation cured material or other clear material;
one or more radiation emitting devices preferably in the ultraviolet range;
a rotating mechanism to move the mold set from a horizontal or vertical load/unload position to vertical fill and cure position at the radiation device; and
one or more injection mechanisms attached to the mold set to fill the mold and then seal at the part wall preventing cure of material in the line.

12. The invention of claim 11 with a shaped shutter for the radiation source that can be designed to selectively irradiate portions of the part in sequence as it is withdrawn from in front of said radiation source.

13. A machine for casting radiation cured material comprising the steps of:
a mold set made of a clears radiation cured material or other clear material;
one or more radiation emitting devices preferably in the ultraviolet and visible range;
a rotating mechanism to move the mold set from a horizontal or vertical load/unload position to vertical fill and cure position at the radiation device;
one injection mechanism to partially fill the mold cavity after which said injection mechanism is removed and a tube is inserted to vent the mold cavity; and
a method for rotating the mold simultaneously in two axis 90 degrees apart while at the cure station to evenly coat the inside of the mold with radiation curable material prior to and during curing.

14. The invention of claim 13 with a pressurized container to deliver radiation curable material to the injection mechanisms.

15. The invention of claim 13 with a method to automatically stop the rotating mechanism and reverse rotation at that point.

16. The invention of claim 13 with a method to eject the part with a pin or other means to positively remove the part from the mold set.

17. A process for casting radiation cured material comprising the steps of:
a mold set made of a clear, radiation cured material or other clear material;
one or more radiation emitting devices preferably in the ultraviolet and visible range;
a rotating mechanism to move the mold set from a horizontal or vertical load/unload position to vertical fill and cure position at the radiation device;
one injection mechanism to partially fill the mold cavity after which a tube is inserted to vent the said cavity; and
a method for rotating the mold simultaneously in two axis 90 degrees apart while at the cure station to evenly coat the inside of the mold with radiation curable material prior to and during curing.

18. An open metal box to create mold halves for inventions 1, 11, 13, and 17 comprising of:
dowel pins that accurately locate the pattern halves in the box;
conical pins and holes to properly orient the matching mold halves; and
has a means to create openings for the injection mechanisms such as properly shaped pins secured to the box.

19. The invention of claim 18 with other than a flat bottom to allow the creation of more complex parting lines.
